(19) United States
(12) Patent Application Publication
(10) Pub. No.: US 2026/0258823 A1
(43) Pub. Date: Sep. 3, 2026

(54) CONNECTING DEVICE AND SYSTEM

(71) Applicant: KUKA Deutschland GmbH, Augsburg (DE)

(72) Inventors: Martin Riedel, Augsburg (DE); Tom Clauder, Augsburg (DE)

(73) Assignee: KUKA Deutschland GmbH, Augsburg (DE)

(21) Appl. No.: 18/876,052

(22) PCT Filed: Aug. 23, 2023
(86) PCT No.: PCT/EP2023/073132

§ 371 Date: Dec. 17, 2024

(30) Foreign Application Priority Data
Sep. 9, 2022 (DE) 10 2022 122 946.7

(51) Int. Cl. F16B 1/00

(52) U.S. Cl. CPC F16B 1/00

(57) ABSTRACT

A connecting device for mechanically interlocking a connection of a first object to a second object. The device includes an unlocking means arranged on a counter-coupling means and designed to respond to a relative turning of a coupling means and a counter-coupling means about an axis of rotation parallel to a plugging direction by moving a locking element of the coupling means in a predetermined relative rotational angle position region of the coupling means, and moving the counter-coupling means out of its locking position into an unlocking position, in which the locking element of the coupling means and the counter-locking element of the counter-coupling means are disengaged. The coupling means and the counter-coupling means can be separated from each other opposite the plugging direction.

### CROSS-REFERENCE TO RELATED APPLICATIONS

This application is a national phase application under 35 U.S.C. § 371 of International Patent Application No. PCT/EP2023/073132, filed Aug. 23, 2023 (pending), which claims the benefit of priority to German Patent Application No. DE 10 2022 122 946.7, filed Sep. 9, 2022, the disclosures of which are incorporated by reference herein in their entirety.

### TECHNICAL FIELD

The invention relates to a connecting device for the mechanically interlocking connection of a first object to a second object, and an associated system.

### BACKGROUND

EP 2 040 572 B1 describes a mechanical-magnetic connecting structure with a locking device with at least one spring locking element, which is arranged in a connection module, and a movable locking piece for interlocking the connection modules, which piece is arranged in another connection module. The spring locking element is designed in such a way that it is pressed against the locking piece when the connecting structure is closed. The spring locking element, the locking piece, and the surface portions of the spring locking element and the locking piece that come into contact with one another are designed such that the spring locking element is deflected in a structurally determined direction and snaps into the locking piece when the locking element and the locking piece move towards one another.

### SUMMARY

The object of the invention is to provide a connecting device for the mechanically interlocking connection of a first object to a second object and an associated system, wherein the connecting device can be locked and/or unlocked in a simple or intuitive manner, in particular can be locked and/or unlocked with one hand, specifically without the need for separate unlocking actuating means.

The object is achieved by a connecting device for the mechanically interlocking connection of a first object to a second object, comprising:

a coupling means with a first fastening portion for fastening the coupling means to the first object, with a socket with an opening through which a socket cavity of the socket is accessible in an axial plugging direction, and at least one locking element which is adjustably mounted between a locking position and an unlocking position and which, in its locking position, projects into the socket cavity of the socket and, in its unlocking position, releases the socket cavity of the socket, a counter-coupling means with a second fastening portion for fastening the counter-coupling means to the second object, with a plug corresponding to the socket of the coupling means with a shaft that can be inserted into the opening of the socket cavity of the socket in the axial plugging direction, and at least one counter-locking element that cooperates in an interlocking manner in the locking position of the locking element of the socket, wherein the socket cavity of the socket and the shaft of the plug corresponding to the socket cavity have cross-sectional contours matched to one another which allow a relative rotation of the coupling means and the counter-coupling means about an axis of rotation parallel to the plugging direction in a connected state of the coupling means and the counter-coupling means, further comprising an unlocking means arranged on the counter-coupling means, which is designed, when the coupling means and the counter-coupling means are rotated relative to each other about the axis of rotation parallel to the plugging direction, to move the locking element of the coupling means in a predetermined relative rotation angle position range of the coupling means and the counter-coupling means from its locking position into an unlocking position in which the locking element of the coupling means and the counter-locking element of the counter-coupling means are disengaged, so that the coupling means and the counter-coupling means can be separated from each other opposite the plugging direction.

The connecting device forms an interlocking connecting element. The connecting device comprises two separable connecting means, namely the coupling means and the counter-coupling means, which can be separated in a connected state and coupled to one another, i.e., connected, from a separated state. The connecting device can be used to connect or separate any two objects. In order to be able to connect the coupling means to the one object, it has a first fastening portion. In order to be able to connect the counter-coupling means to the other object, it has a second fastening portion. The first fastening portion and the second fastening portion can in each case be, for example, screwed, glued, or snapped onto the associated object. Alternatively, the first fastening portion and the second fastening portion can in each case also be formed in one piece with the associated object, for example molded onto a housing of the respective object.

The positive connection of coupling means and counter-coupling means substantially comprises a combination of a plug and a socket in the general sense. In this respect, a plug is understood to mean a projection, which can also be referred to as a peg, tenon, pin, or male connecting part. In this respect, the term socket refers to a recess, which can also be referred to as a receptacle, base, outlet, or female connector. The plug and socket are designed to correspond, so that they can be inserted into each other with an interlocking fit with little or no play.

In the connecting device according to the invention, the socket cavity of the socket and the shaft of the plug corresponding to the socket cavity have cross-sectional contours matched to one another which allow a relative rotation of the coupling means and the counter-coupling means about an axis of rotation parallel to the plugging direction in a connected state of the coupling means and the counter-coupling means. According to the invention, the connecting device is intended to make it possible for the two objects connected to one another via the connecting device to continue to be rotated relative to one another despite the existing connection. The rotation of the two objects relative to each other can either be possible for a full 360 degrees, or in some cases only for a smaller angle of rotation, for example, depending on the design, a maximum of only 270 degrees, 180 degrees or 90 degrees.

The axis of rotation permitted according to the design also defines the plugging direction in which the coupling means and the counter-coupling means are plugged together or, in the opposite direction, the separation direction in which the coupling means and the counter-coupling means can be separated from each other again.

To ensure that the coupling means and the counter-coupling means do not inadvertently separate from one another when plugged together, the coupling means has a locking element and the counter-coupling means has a counter-locking element. In the locking position of the locking element and the counter-locking element, the coupling means and the counter-coupling means cannot be separated from each other, even if the coupling means and the counter-coupling means are pulled apart from each other in the separation direction. Only when the locking element and the counter-locking element are in the unlocking position can the coupling means and the counter-coupling means be separated from each other in the separation direction.

When the coupling means and the counter-coupling means are put together, the locking element and the counter-locking element automatically move into their locking position in which the coupling means and the counter-coupling means cannot be separated from each other in the separation direction. The unlocking means is provided to bring the locking element and the counter-locking element into their unlocking position.

According to one aspect of the invention, the unlocking means is designed, when the coupling means and the counter-coupling means are rotated relative to each other about the axis of rotation parallel to the plugging direction, to move the locking element of the coupling means in a predetermined relative rotation angle position range of the coupling means and the counter-coupling means from its locking position into an unlocking position in which the locking element of the coupling means and the counter-locking element of the counter-coupling means are disengaged, so that the coupling means and the counter-coupling means can be separated from each other opposite the plugging direction, in particular by pulling the coupling means and the counter-locking element apart from each other in the separation direction.

One aspect of the invention is to create a positive coupling mechanism which can be connected easily and directly and separated again with one hand, in particular without having to operate an additional unlocking input means which has to be operated separately by hand.

Only by rotating the plug relative to the socket should the plug be able to assume an unlocking position and be decoupled opposite the input direction. On the one hand, the unlocking movement should be simple and intuitive, but on the other hand it should only be able to be done deliberately, in order to avoid accidental uncoupling. The main differences between the solutions proposed here are in the geometry of the connector, the snap hook arrangement of the counter-holder, and the way in which the unlocking is haptically designed.

In a further development of the connecting device, the unlocking means can have at least one extension projecting radially outward from the shaft of the plug, which extension is designed to press the locking element into the unlocking position in a first rotation angle position range of the counter-coupling means relative to the coupling means and to leave the locking element in its locking position in a second rotation angle position range of the counter-coupling means relative to the coupling means that is different from the first rotation angle position range, wherein the locking element is spring-loaded into its locking position and in the first rotation angle position range of the counter-coupling means relative to the coupling means, the locking element is pressed radially outward into its unlocking position by the extension of the unlocking means against a spring force.

In this embodiment, the pin of the connector is not completely rotationally symmetrical. Due to additional oppositely situated protrusions on the pin, such as radial projections, the pin is able to expand the counter-holder, in particular with snap hooks on the socket. The protrusions can be located above the undercut or the snap hook contour, at the level of the undercut or the snap hook contour, or below the undercut or the snap hook contour. When the plug is correctly aligned with the counter-holder so that the counter-holder is widened, the pin of the plug can then be removed from the socket. For this purpose, the snap hook contours of the counter-holder, i.e., of the coupling means, must be present only in the region of the protrusion of the pin.

In a further embodiment, the unlocking means can have at least one recess in the outer surface of the shaft, which recess extends axially along the shaft of the plug and is designed to align with the locking element projecting radially inwards into the socket cavity of the coupling means in a first rotation angle position range of the counter-coupling means relative to the coupling means, wherein in a second rotation angle position range of the counter-coupling means relative to the coupling means, which is different from the first rotation angle position range, the unlocking means overlaps with the locking element in the radial direction, so that in this locking position the counter-coupling means is held in an interlocking manner on the coupling means in the axial direction.

In this respect, the plug can also have recesses and thus form a type of key surface in order to run past the existing snap hooks of the counter-holder in a suitable rotational position and to avoid the interlocking.

The advantages are that the coupling direction and decoupling direction are the same, and the fact that no separate, additional decoupling mechanism is necessary.

The counter-coupling means can be coupled to the coupling means via a freewheel such that a relative rotation of the counter-coupling means and the coupling means relative to each other is only possible in one direction of rotation.

With a further addition, a detent can be integrated to keep the angular position stable depending on the detent pitch. In this respect, a reverse lock can be integrated either in the plug or in the socket in order to limit the relative rotation of the coupling means and the counter-coupling means to only one direction of rotation.

In known systems, unlocking or locking by rotation is often completely specified in a defined angular range, for example a 0-degree position for an open position and a 90-degree position for a locked position. Alternatively, the angle range is completely free. Unlocking is then usually done by turning in the direction opposite to the locking rotation. Alternatively, the locking is achieved by a, in particular, 90-degree rotation and is opened again by a further 90-degree rotation in or opposite the locking direction.

Due to the proposed reverse lock, a lock may require up to almost a complete turn to be opened again. However, the necessary rotation for a decoupling depends on whether the joining position of the plug and socket remains free in its orientation or whether this is fixedly defined. The angle of rotation can therefore vary depending on the coupling orientation. However, the unlocking position is then always at a defined twisting orientation of the two bodies relative to each other and should be locked by an additional locking mechanism in order to provide a better feel for the user. Only after a new coupling process can the two bodies be twisted together again.

In a further development, a second stage can be added to ensure greater decoupling security. In the insertion region in front of the counter-holder with snap hook in the housing, the socket has one or more recesses as a second stage, rotated to the expansion rotation position. The plug with protrusion can only be inserted into and locked in the socket if it is correctly oriented to the recess. For the first stage decoupling process, the plug must first be turned to the unlocked position so that it expands the counter-holder and can be pulled out of the snap hook. The plug still has to be pulled out against the socket's counter-holder, as the first stage can be re-locked in any rotational position. The plug must then be rotated further so that the protrusion is aligned with the recesses in the socket. The plug can now be completely removed.

By combining with a reverse lock and uniquely designed recesses and/or protrusions, a decoupling process can require up to one complete revolution, thus providing additional decoupling security.

Thus, the connecting device can be characterized by an intermediate plane into which the counter-locking element of the counter-coupling means is introduced when the counter-coupling means is moved by the coupling means opposite the plugging direction in order to separate the counter-coupling means from the coupling means in the unlocking position, wherein the intermediate plane has interlocking retaining means which initially prevent further separation of the counter-coupling means from the coupling means across the intermediate plane and which only permit this further separation after an additional rotation of the counter-coupling means relative to the coupling means by a further angle of rotation.

In an alternative or additional development, it can be provided that in a relative angular position of the coupling means to the counter-coupling means corresponding to the unlocking position, the plug of the counter-coupling means is held in a force-fitting and/or interlocking manner in its unlockable rotational position relative to the socket of the coupling means by means of a locking device.

The locking device can comprise a pre-tensioned locking pin on the coupling means that projects radially into the socket cavity, which pin, in the unlocking position, mechanically locks into a recess in the shaft of the plug which corresponds to the locking pin of the counter-coupling means.

The locking device can comprise a first magnet attached to the coupling means, which in the unlocking position magnetically interacts with a second magnet arranged on the counter-coupling means in order to hold the counter-coupling means in its current rotational angle position relative to the coupling means in the unlocking position.

Such embodiments are explained in more detail below with reference to FIG. 1 to FIG. 7.

In a modified embodiment, a pair of counter-holders is held spring-loaded in a frame in such a way that when inserted they can move back laterally from the locking body of a plug along the axis of rotation and allow the plug to be inserted into the frame. In this embodiment, the locking bodies are not formed around the circumference of the plug, but have free areas.

In the locked state, the locking body is held in an interlocking manner on the segments of the counter-holder in the axial and radial directions. Rotating the plug around the axis of rotation allows the two coupling partners to remain in a locked angular position. Only when a decoupling angle is exceeded, for example 45 degrees, 90 degrees or 180 degrees, does the overlap disappear, since the locking body lies between the counter-holders from this decoupling angle onwards. The plug can thus be removed again in the axial direction after a corresponding rotation.

Such embodiments are explained in more detail below with reference to FIG. 8 to FIG. 13.

The counter-holders and the locking body can also take on other forms as follows.

In such a different embodiment, the counter-holder, spring, and guide are combined into one element, which can be designed for example as an elastically bendable bending rod or bending rods that are mounted in a frame.

Particularly advantageous in such a case is the rod shape with a profile which has a higher bending resistance in a direction out of the plane perpendicular to the axis of rotation and in the transverse direction, i.e., in the case of an elastic deformation within the plane perpendicular to the axis of rotation. Alternatively, a boundary wall of the frame can cover the bending rods in such a way that they do not behave too flexibly in a direction out of the plane perpendicular to the axis of rotation.

Such embodiments are explained in more detail below with reference to FIG. 14 to FIG. 16.

It is also possible to reverse the returning and spring-loaded locking elements from the frame to the plug.

Thus, the returning and spring-loaded locking elements can be provided on the plug and the rigid counter-holders can be provided on the frame.

Such embodiments are explained in more detail below with reference to FIG. 17 to FIG. 19.

Another aspect of the invention is the haptic aspect, which should enable the user to feel the time and the correct position at which decoupling is possible. In addition, it should be possible to signal to the user when a decoupling process has begun or is about to begin, and/or that the two coupling partners (coupling means or plug and counter-coupling means or socket) will be separated if the movement is continued.

In a first variant, it can be provided that a locking body is rotated into its unlocking position; a spring-loaded molded body then engages in a beveled cutout in the plug and arrests the extender in this position.

If this cutout is designed linearly like a groove along the direction of the axis of rotation, the plug can be removed without force. If this cutout is local, point-shaped, or cylindrical, like a hole, the plug must first be pulled against the spring force in order to be removed.

The cutout can be made on the locking body or at any point on the plug. Likewise, a reversal of the cutout and the molded body is always possible, i.e., the cutout can be arranged optionally on the plug or on the socket, and accordingly the molded body can be arranged on the socket or the plug as a complementary part.

Such a variant allows rotation into the unlocked position, but also beyond it and back again.

Such embodiments are explained again in more detail below with reference to FIG. 20 and FIG. 21.

In a second variant, it can be provided that the haptic means realizes an interlocking connection between the elements of the cutout and the molded body, in contrast to the first variant, in which a force-fit connection is realized.

In the case of the second variant, the cutout must be designed as a groove directed in the direction of the axis of rotation.

The second variant only allows rotation into the unlocked position, but does not allow backwards or further rotation. Here the plug must first be completely removed before the connection can be re-established by reinserting it.

Such embodiments are again explained in more detail below with reference to FIG. 22 and FIG. 23.

A third variant is comparable to the first variant 1 and a local cutout, but with the difference that here one or more pairs of magnets take over the center arrest, instead of a mechanically force-locking connection. Here the user feels when he comes close to the position in which the magnets are attracting each other.

The magnets can be arranged radially or in a similar position axially to the rotational axis direction.

The magnets can be separated from each other either by shearing or by pulling for the final decoupling.

Such embodiments are again explained in more detail below with reference to FIG. 24 and FIG. 25.

In a fourth variant, the magnet arrangement both centers the plug in the unlocked position and generates a characteristic overshoot force when the plug is rotated by an angular amount from the unlocked position. This solution thus represents a bi-stable system.

Such embodiments are again explained in more detail below with reference to FIG. 26 and FIG. 27.

In a fifth variant, the plug with the locking body is held in the unlocked position by locking elements on the counter-holder segments as soon as it has passed over the locking elements.

This fifth variant only allows rotation into the unlocked position, but does not allow backwards or further rotation. Here the plug must first be completely removed before the connection can be re-established by reinserting it.

The user feels a definite effort when overcoming the locking elements. In a variation, the locking elements can also be part of the frame.

Such embodiments are again explained in more detail below with reference to FIG. 28 and FIG. 29.

In a sixth variant, the plug with the locking body is held in the unlocked position by the flanks of the counter-holder segments as soon as the unlocked position is reached. This is achieved by the plug with its locking body moving over an elastic spring element in the frame, which lifts it slightly and moves it outwards.

This sixth variant also only allows rotation into the unlocked position, but does not allow backwards or further rotation. Here, too, the plug must first be completely removed before the connection can be re-established by reinserting it. In contrast to the second and fifth variants, a connection can also be re-established by pressing the plug against the spring at the level of the frame and then rotating it back into the locking position.

The user feels a definite effort when overcoming the spring element. In a modification, the spring element can also be part of the plug, in particular of the locking body.

Such embodiments are explained in more detail below with reference to FIG. 30 to FIG. 32.

A seventh variant is based in principle on the sixth variant, with the difference that the mechanical spring elements are replaced by pairs of magnets, which are in particular arranged in such a way that they function by a repulsive effect.

Such embodiments are explained in more detail below with reference to FIG. 33 to FIG. 35.

In a further type of embodiments, the unlocking is not carried out by “free rotation” into a position without overlapping of the locking body and the counter-holder; rather, the counter-holder, in particular the counter-holder segments, are opened radially outwards by rotation of the plug relative to the frame until the plug can be removed in the direction opposite the plugging direction.

This variant, for example, has four segments of counter-holders, each of which has shaped elements, in particular shaped bevels, on at least one side and in particular on both sides. The plug has for example a continuous locking body that is held in interlocking fashion by the counter-holders. In addition, the plug has release elements at the level of the counter-holders, which are located in the free pockets between the counter-holders when locked. A rotation causes contact and a guided pressing of the segments. The size of the pockets in relation to the size of the release elements defines the unlocking time. If the ratio is small, triggering occurs even with a small relative rotation. If the ratio is large, it is the other way around and the plug remains coupled within a larger angular range.

Such embodiments are explained in more detail below with reference to FIG. 36 to FIG. 40.

Another type of embodiment is comparable to the third variant, but with the difference that here the function of the release elements is taken over by segmented locking bodies and their flanks, which, when rotated, meet the shaped elements of the joint holder segments. When locked, the segmented locking bodies extend into cavities under the joint holder segments. A necessary free space is formed between the locking body segments.

Such embodiments are explained in more detail below with reference to FIG. 41 to FIG. 46.

Another variant with magnets relates to a possible embodiment that does not require any free spaces or trigger shaped elements by using magnets that are placed on the plug and the counter-holder, i.e., the socket. The alignment is chosen in such a way that the magnet pairs attract each other when locked and provide additional stability, in particular against rotation of the plug. If a first force threshold is exceeded, the plug including the inner magnets can be rotated. If the magnets strike the outer magnets, which are directed in the opposite direction in this position, they have a repulsive effect and push the counter-holder segments radially back against weaker spring forces.

Such embodiments are explained in more detail below with reference to FIG. 47 to FIG. 49.

Analogous to the variant just described, in a modification it can also be provided that only one bar magnet is arranged in the middle of the plug and two segments are formed as counter-holders, each with one magnet, with one “north” and one “south” pointing inwards.

Such an embodiment is again explained in more detail below with reference to FIG. 50.

The coupling means can thus comprise a first repulsion magnet and the counter-coupling means can comprise a second repulsion magnet, wherein the first repulsion magnet and the second repulsion magnet are arranged relative to one another in such a way that in an unlocking position of the coupling means relative to the counter-coupling means, the at least one first repulsion magnet in cooperation with the second repulsion magnet causes a mutually repulsive magnetic force which presses the locking element adjustably mounted on the coupling means into its unlocking position.

The object is also achieved by a system comprising a robot device, a robotic input device and a connecting device according to one or more of the described embodiments and/or variants, wherein the coupling means is connected to the robot device as first object by means of its first fastening portion and the counter-coupling coupling means is connected to the robotic input device as second object by means of its second fastening portion, wherein the connecting device is designed and configured according to one of the described embodiments and/or variants for manually selectively connecting and separating the robotic input device and the robot device.

The object is also achieved by a system comprising a robot device, a robotic input device, and a connecting device according to one or more of the described embodiments and/or variants, wherein the coupling means is connected to the robotic input device as a first object by means of its first fastening portion and the counter-coupling means is connected to the robot device as a second object by means of its second fastening portion, wherein the connecting device is designed and configured according to one or more of the described embodiments and/or variants for manually selectively connecting and separating the robotic input device and the robot device.

As already described, a main feature of this coupling unit is the relative rotation of the coupling partners about the joining and releasing direction.

In robotic devices, which usually comprise a robot arm and a robot controller, robotic input devices, so-called handheld devices or HMIs, are used to enable making manual inputs that control or program the robot controller, or even to be able to move the robot arm in a manual mode by making corresponding inputs on the input device. Such input devices have recently become miniaturized so that they can be handled in particular with one hand.

Thus, the input device can have one coupling partner and, for example, one link of the robot arm can directly have the other coupling partner in order to be able to detachably couple the input device directly to the robot arm.

If a rotation of the input device by, for example, 360 degrees without unlocking is intended to be possible, an additional external unlocking mechanism can also be installed.

For example, additional trigger mechanisms can be useful which are directly integrated into the special coupling partners, such as the input device, and which, when actuated, either carry out an isolated rotation of the plug or pull the counter-holder segments radially outwards without the plug having rotated.

Such embodiments are again explained in more detail below with reference to FIG. 51 and FIG. 52.

A variant in which the input device itself contains additional unlocking actuators on each side is also possible.

Such an embodiment is again explained in more detail below with reference to FIG. 53.

Specific embodiments of the invention are explained in more detail in the following description with reference to the accompanying drawings. Specific features of these embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIGS. 1 to 7 depict different embodiments of connecting devices with elasto-mechanically interacting locking elements and counter-locking elements,

FIG. 8 to FIG. 19 depict various embodiments of connecting devices with spring-elastic interacting locking elements and counter-locking elements,

FIG. 20 and FIG. 21 depict a first variant of a connecting device with a haptic device which can haptically report an unlocking position of the connecting device,

FIG. 22 and FIG. 23 depict a second variant of a connecting device with a haptic device which can haptically report an unlocking position of the connecting device,

FIG. 24 and FIG. 25 depict a third variant of a connecting device with a haptic device which can haptically report an unlocking position of the connecting device,

FIG. 26 and FIG. 27 depict a fourth variant of a connecting device with a haptic device which can haptically report an unlocking position of the connecting device,

FIG. 28 and FIG. 29 depict a fifth variant of a connecting device with a haptic device which can haptically report an unlocking position of the connecting device,

FIG. 30 to FIG. 32 depict a sixth variant of a connecting device with a haptic device which can haptically report an unlocking position of the connecting device,

FIG. 33 to FIG. 35 depict a seventh variant of a connecting device with a haptic device which can haptically report an unlocking position of the connecting device,

FIG. 36 to FIG. 46 depict embodiments in which the unlocking is not carried out by “free rotation” into a position without overlapping of the locking body and the counter-holder; rather, the counter-holder, in particular the counter-holder segments, are opened radially outwards by relative rotation of the plug relative to the frame,

FIG. 47 to FIG. 50 depict embodiments analogous to FIG. 36 to FIG. 46, but with magnetically acting plugs and counter-holders,

FIG. 51 to FIG. 53 depict different embodiments in the use of a connecting device together with a robotic input device, and

FIG. 54 is a schematic representation of a system comprising a robot device, a robotic input device, further terminal devices, and a corresponding connecting device.

### DETAILED DESCRIPTION

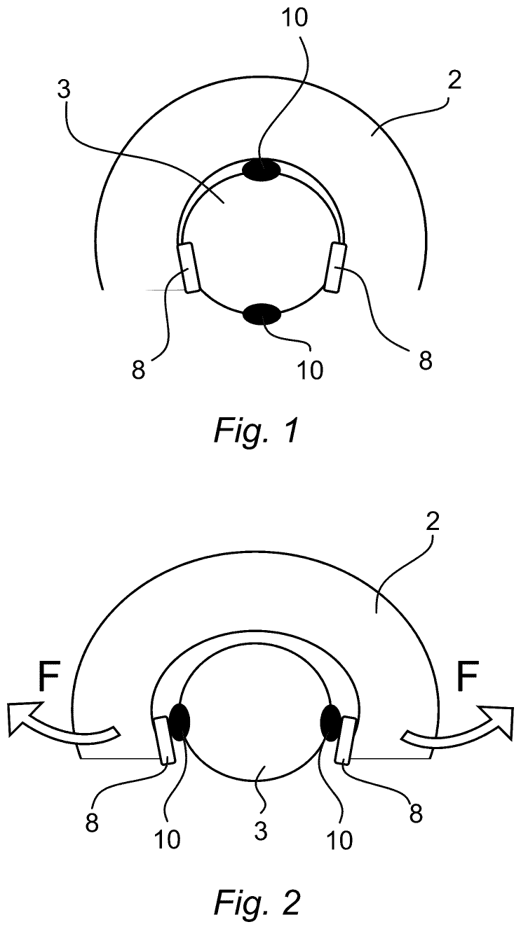

In FIG. 1 and FIG. 2, a basic embodiment of a connecting device 1 in accordance with the principles of the invention is shown schematically. FIG. 1 shows the connecting device 1 in a locking position and FIG. 2 shows the connecting device 1 in an unlocking position.

The connecting device 1 is substantially constructed in two parts and comprises a coupling means 2 and a corresponding counter-coupling means 3.

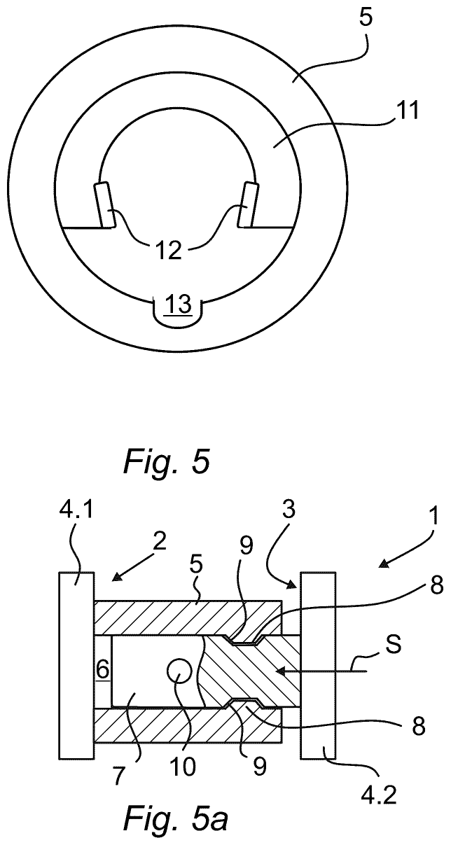

The coupling means 2 has a first fastening portion 4.1 for fastening the coupling means 2 to a first object. The coupling means 2 also has a socket 5 with an opening through which a socket cavity 6 of the socket 5 is accessible in an axial plugging direction S (FIG. 5a).

The counter-coupling means 3 has a second fastening portion 4.2 for fastening the counter-coupling means 3 to a second object. The counter-coupling means 3 also has a plug 7 corresponding to the socket 5 of the coupling means 2 with a shaft that can be inserted into the opening of the socket cavity 6 of the socket 5 in the axial plugging direction S (FIG. 5a).

The coupling means 2 has at least one locking element 8 which is adjustably mounted between a locking position (FIG. 1) and an unlocking position (FIG. 2), which in its locking position projects into the socket cavity 6 of the socket 5 and in its unlocking position releases the socket cavity 6 of the socket 5.

The counter-coupling means 3 has at least one counter-locking element 9 which cooperates in an interlocking manner in the locking position of the locking element 8 of the socket 5. In the case of the present embodiment of FIG. 1 to FIG. 5, the at least one counter-locking element 9 is formed by at least one undercut in the outer surface of the plug 7, behind which the at least one locking element 8 of the coupling means 2 engages in an interlocking manner in the locking position (FIG. 1) and is positioned out of the undercut in the unlocking position (FIG. 2).

The socket cavity 6 of the socket 5 and the shaft of the plug 7 corresponding to the socket cavity 6 have cross-sectional contours matched to one another which allow a relative rotation of the coupling means 2 and the counter-coupling means 3 about an axis of rotation parallel to the plugging direction S in a connected state of the coupling means 2 and the counter-coupling means 3.

According to the principles of the invention, the counter-coupling means 3 has at least one further unlocking means 10 which is designed, when the coupling means 2 and the counter-coupling means 3 are rotated relative to each other about the axis of rotation parallel to the plugging direction S, to move the locking element 8 of the coupling means 2 in a predetermined relative rotation angle position range of the coupling means 2 and the counter-coupling means 3 from its locking position FIG. 1 into an unlocking position FIG. 2 in which the locking element 8 of the coupling means 2 and the counter-locking element 9 of the counter-coupling means 3 are disengaged, so that the coupling means 2 and the counter-coupling means 3 can be separated from each other opposite the plugging direction S. In the concrete embodiment of FIG. 1 to FIG. 5, the coupling means 2 has exactly two locking elements 8. These two locking elements 8 are arranged opposite each other.

The unlocking means 10 of the counter-coupling means 3 can have at least one extension projecting radially outward from the shaft of the plug 7, which extension is designed to press the at least one locking element 8 into the unlocking position in a first rotation angle position range of the counter-coupling means 3 relative to the coupling means 2, according to FIG. 2, and to leave the locking element 8 in its locking position in a second rotation angle position range of the counter-coupling means 3 relative to the coupling means 2, which is different from the first rotation angle position range, according to FIG. 1, wherein the locking element 8 is spring-loaded into its locking position and in the first rotation angle position range of the counter-coupling means 3 relative to the coupling means 2, the locking element 8 is pressed radially outward into its unlocking position by the extension of the unlocking means 10 against a spring force. In the case of the embodiment according to FIG. 1 and FIG. 2, the spring force is generated by a spring-elastic expansion of the coupling means 2, i.e., the outer wall of the socket 5.

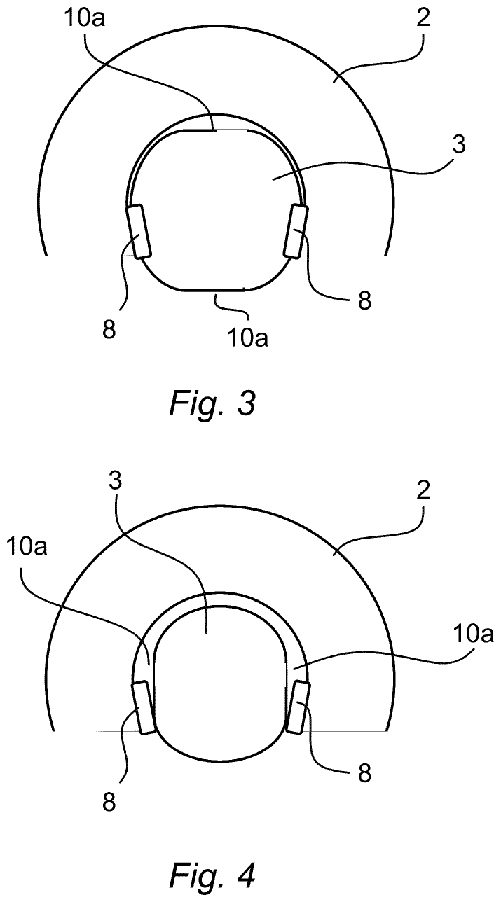

In the modified embodiment according to FIG. 3 and FIG. 4, the unlocking means 10 has at least one recess 10a in the outer surface of the shaft, which recess extends axially along the shaft of the plug 7 and is designed to align with the locking elements 8 projecting radially inwards into the socket cavity 6 of the coupling means 2 in a first rotation angle position range of the counter-coupling means 3 relative to the coupling means 2, according to FIG. 4, wherein in a second rotation angle position range of the counter-coupling means 3 relative to the coupling means 2, which is different from the first rotation angle position range, the unlocking means 10 overlaps with the locking elements 8 in the radial direction, so that in this locking position, according to FIG. 3, the counter-coupling means 3 is held in a form-fitting manner on the coupling means 2 in the axial direction. The recesses 10a can be formed by axially extending grooves or axially extending flattened parts on the outer wall of the shaft of the plug 7.

In a further development, as shown in FIG. 5, a second stage can be added to ensure a higher decoupling security. In the insertion region, in front (in the axial plugging direction) of a counter-holder 11 with snap hooks 12 in the housing, the socket 5 has a recess 13, as shown in FIG. 5, or a plurality of recesses 13 as a second stage, rotated to the expansion rotation position. The plug 7 with its protrusion, for example the unlocking means 10, can only be inserted and locked into the socket 5 in the correct orientation to the recess 13. For the decoupling process of the first stage, the plug 7 must first be rotated to the unlocking position (FIG. 2 or FIG. 4) so that it expands the counter-holder 11 or drives the locking elements 8 apart from each other and can be pulled out of the snap hook or the counter-locking elements 9. The plug 7 must still be pulled specifically opposite the counter-holder of the socket 5, since the re-locking of the first stage in any rotational position is possible. The plug 7 must then be rotated further so that the protrusion, for example the unlocking means 10, is aligned so as to fit the recess 13 or recesses 13 of the socket 5. Now the plug 7 can be completely removed.

By combining with a reverse lock and uniquely designed recesses 13 and/or protrusions, a decoupling process can require up to one complete revolution, thus providing additional decoupling security.

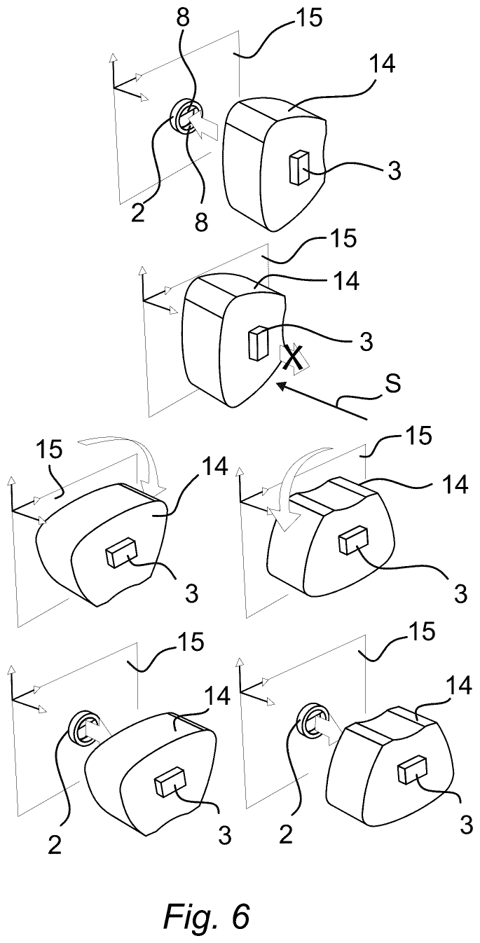

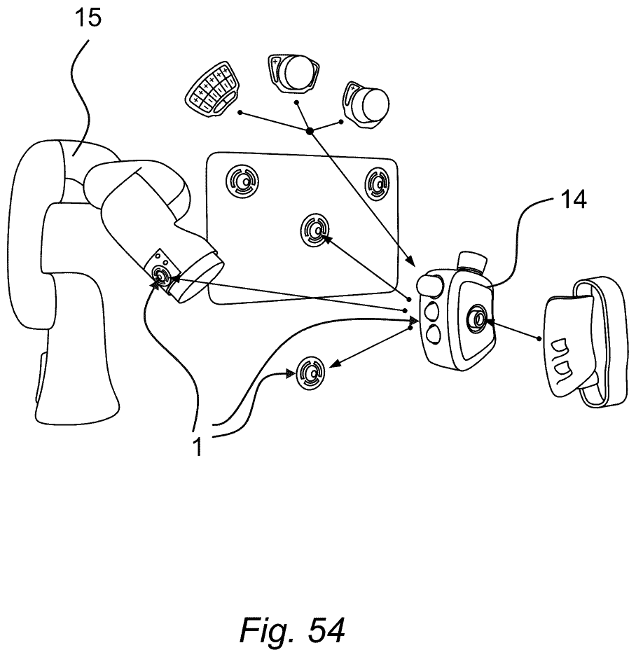

FIG. 6 illustrates the coupling and decoupling of a coupling means 2 from the counter-coupling means 3, wherein the counter-coupling means 3 is arranged, for example, on an input device 14 of a robot device 15 (FIG. 54) and the coupling means 2 can be arranged on the robot device 15 itself. For better illustration, the input device 14 has two identically designed counter-coupling means 3 on opposite sides. On the one hand, this makes it possible in use for the input device 14 to be coupled to the robot device 15 either on the left or on the right side. On the other hand, the oppositely situated counter-coupling means 3 also illustrates the shape, size, and orientation of the opposite similar counter-coupling means 3, which is not visible in the selected perspective representation, but which interacts with the visible counter-coupling means 3. In the upper illustration it can be seen that the counter-coupling means 3 can engage between the two locking elements 8 in the manner of a snap-locking connection, although the locking elements 8 are in their locking positions. An axial removal opposite the plugging direction S is not possible in the coupled state in this orientation of the input device 14, as can be seen from the crossed-out arrow in the second illustration from the top. If the input device 14 is rotated either clockwise (left middle illustration) or counterclockwise (right middle illustration), the counter-coupling means 3 receives the appropriate orientation in order to be able to pass the locking elements 8 in the axial direction opposite the plugging direction S, whereby the input device 14 can be separated from the robot device 15 again.

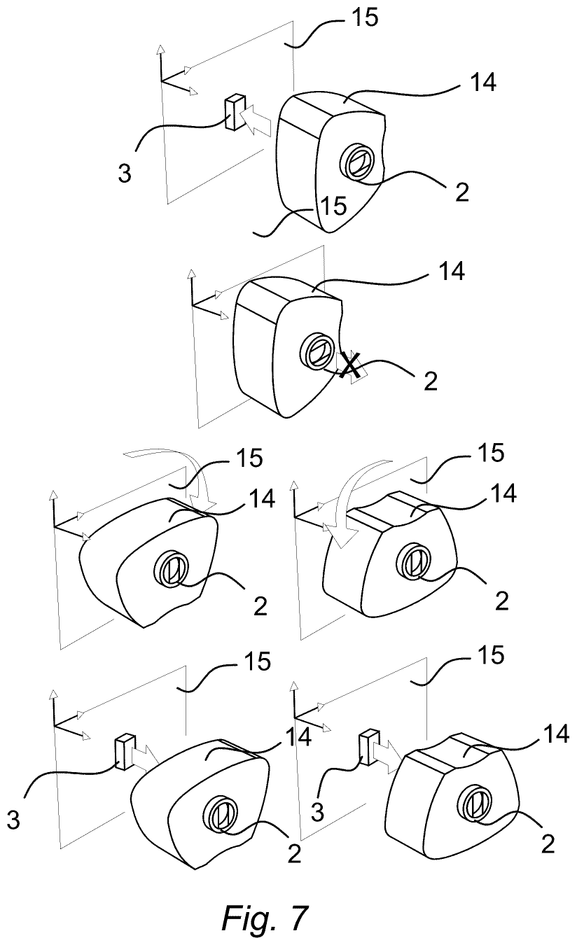

FIG. 7 shows an analogous example to FIG. 6, but wherein the coupling means 2 and the counter-coupling means 3 are interchanged, i.e., the input device 14 now has the coupling means 2 and the robot device 15 has the counter-coupling means 3.

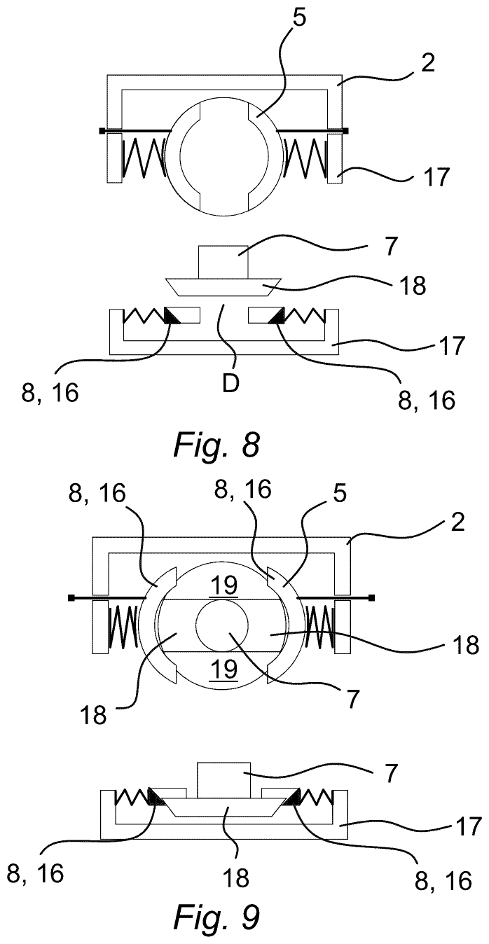

FIG. 8 to FIG. 13 show a pair of counter-holders 16 as locking elements 8, which are spring-loaded and guided in a frame 17 in such a way that they can move back laterally from a locking body 18 of the plug 7 when it is inserted along the axis of rotation D and allow the plug 7 to extend into the frame 17. In this embodiment, the locking bodies 18 are not formed around the circumference of the plug 7, but have free areas 19.

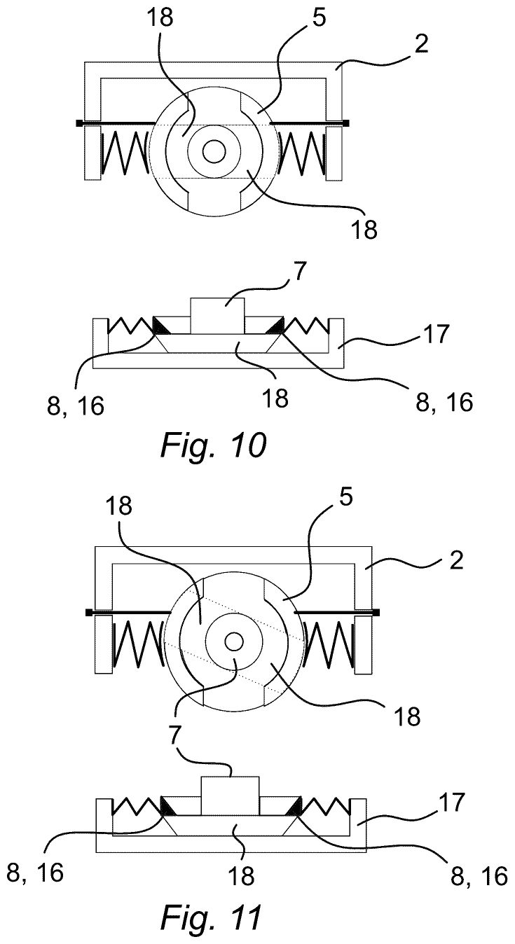

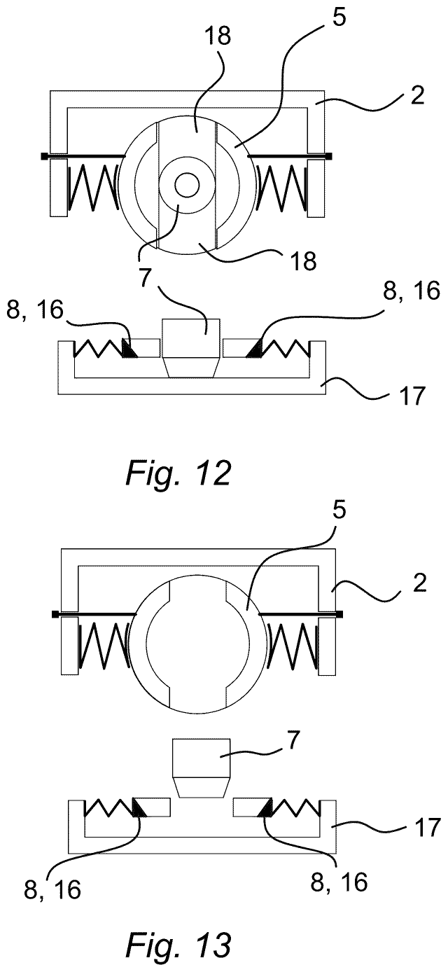

In the locked state, the locking body 18 or the locking bodies 18 are held in an interlocking manner on the segments of the counter-holders 16 in the axial and radial directions (FIG. 10). Rotating the plug around the axis of rotation allows the two coupling partners to remain locked in the angular position (FIG. 11). Only when a decoupling angle is exceeded, for example 90 degrees as shown (FIG. 12), does the overlap disappear, since the locking body 18 lies between the counter-holders 16 from this decoupling angle onwards. The plug 7 can thus be removed again in the axial direction after a corresponding rotation (FIG. 13).

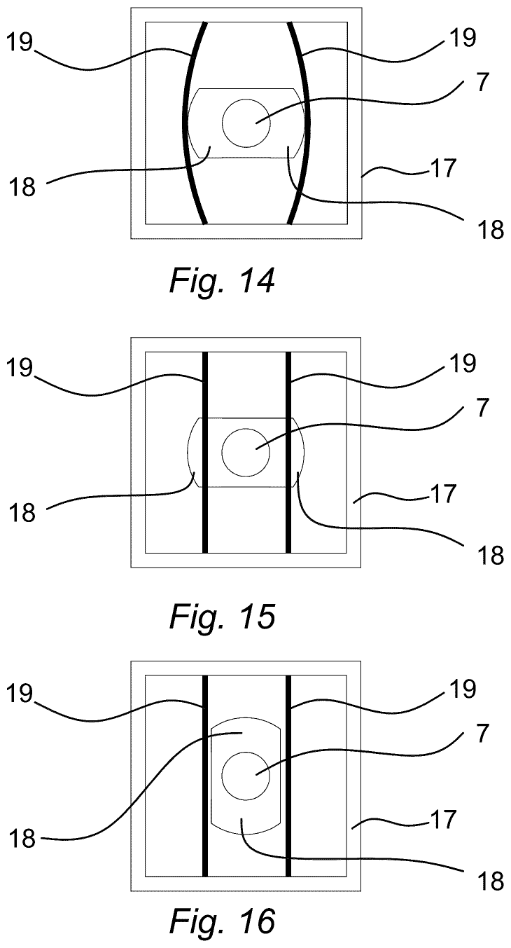

In a special modification according to FIG. 14 to FIG. 16, the counter-holder 16, spring, and guide are combined into one element, which can be designed for example as an elastically bendable bending rod 19 or bending rods 19 which are mounted in the frame 17.

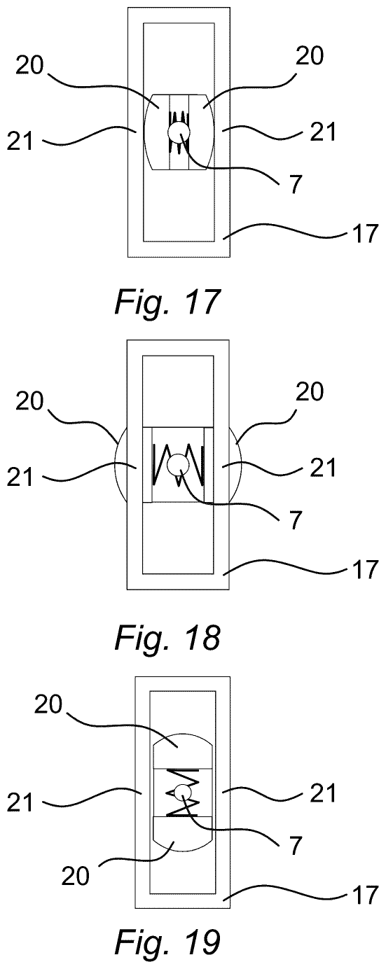

In another special modification according to FIG. 17 to FIG. 19, a reversal of the returning and spring-loaded locking elements 20 from frame 17 to plug 7 is realized.

Thus, the returning and resilient locking elements 20 can be provided on the plug 7 and the rigid counter-holders 21 can be provided on the frame 17.

Haptic devices are explained in more detail below.

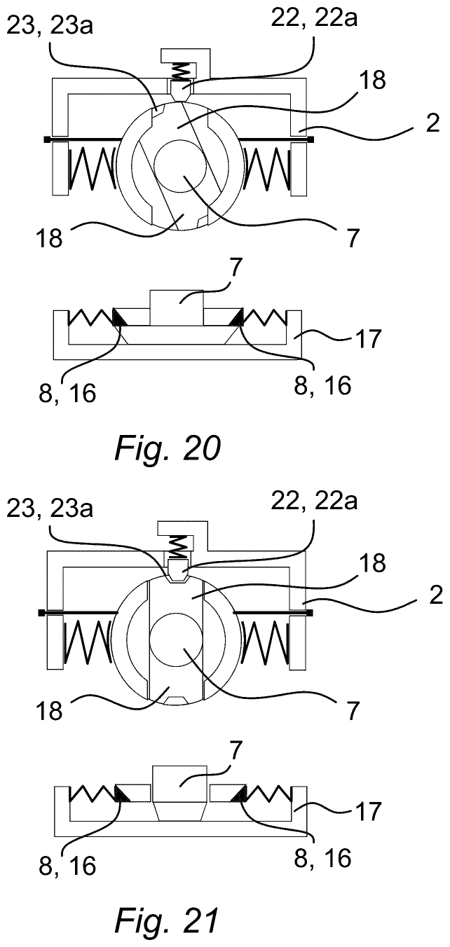

In a first variant according to FIG. 20 and FIG. 21, it can be provided that the locking body 18 is rotated into its unlocking position (FIG. 21), a spring-loaded molded body 22 then engages in a beveled cutout 23 in the plug 7 and locks the plug 7 in this position.

The molded body 22 interacts with the cut-out 23 to form a locking device 35.

In a relative angular position of the coupling means 2 to the counter-coupling means 3 corresponding to the unlocking position, the plug 7 of the counter-coupling means 3 can thus be held stabilized in its unlockable rotational position relative to the socket 5 of the coupling means 2 in a force-fitting and/or interlocking manner by means of the locking device 35.

The locking device 35 can comprise a pre-tensioned locking pin 22a (molded body 22) on the coupling means 2 that projects radially into the socket cavity 6 and which, in the unlocking position (FIG. 21), mechanically locks into a recess 23a (cutout 23) in the shaft of the plug 7 which corresponds to the locking pin 22a of the counter-coupling means 3.

If this cutout 23 is designed linearly like a groove along the direction of the axis of rotation, the plug 7 can be removed without force. If this cutout is local, point-shaped or cylindrical, like a hole, the plug 7 must first be pulled against the spring force in order to be able to be removed.

The cutout 23 can be made on the locking body 18 or at any point on the plug 7. Likewise, a reversal of the cutout 23 and the molded body 22 is always possible, i.e., the cutout 23 can be arranged optionally on the plug 7 or on the socket 5, and accordingly the molded body 22 can be arranged on the socket 5 or on the plug 7 as a complementary part. Such a variant allows rotation into the unlocked position, but also beyond it and back again.

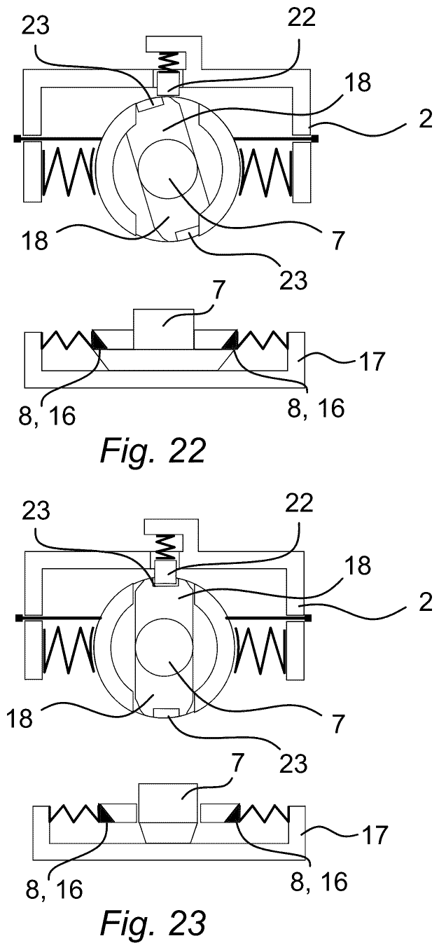

In a second variant according to FIG. 22 and FIG. 23, it can be provided that in the haptic means an interlocking connection of the elements of cutout 23 and molded body 22 is realized, in contrast to the first variant according to FIG. 20 and FIG. 21, in which a force-fit connection is realized. In the case of the second variant, the cutout 23 must be designed as a groove directed in the direction of the axis of rotation. The second variant only allows rotation into the unlocked position, but does not allow backwards or further rotation. Here the plug 7 must first be completely removed before the connection can be re-established by reinserting it.

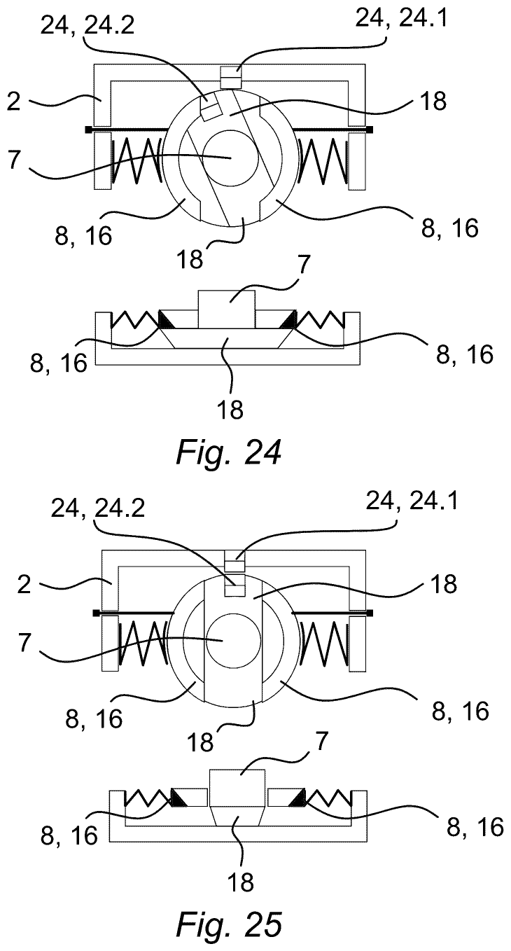

A third variant according to FIG. 24 and FIG. 25 is comparable to the first variant according to FIG. 20 and FIG. 21 and a local cutout 23, but with the difference that here one or more magnet pairs 24 take over the center arrest, instead of a mechanically force-locking connection. Here the user feels when he comes close to the position in which the magnets 24 are attracting each other. The magnets 24 can be arranged radially or in a similar position axially to the rotational axis direction. The magnets 24 can be separated from each other either by shearing or by pulling for the final decoupling.

The locking device 35 can accordingly comprise a first magnet 24.1 attached to the coupling means 2, which in the unlocking position magnetically interacts with a second magnet 24.2 arranged on the counter-coupling means 3 in order to hold the counter-coupling means 3 in its current rotational angle position relative to the coupling means 2 in the unlocking position.

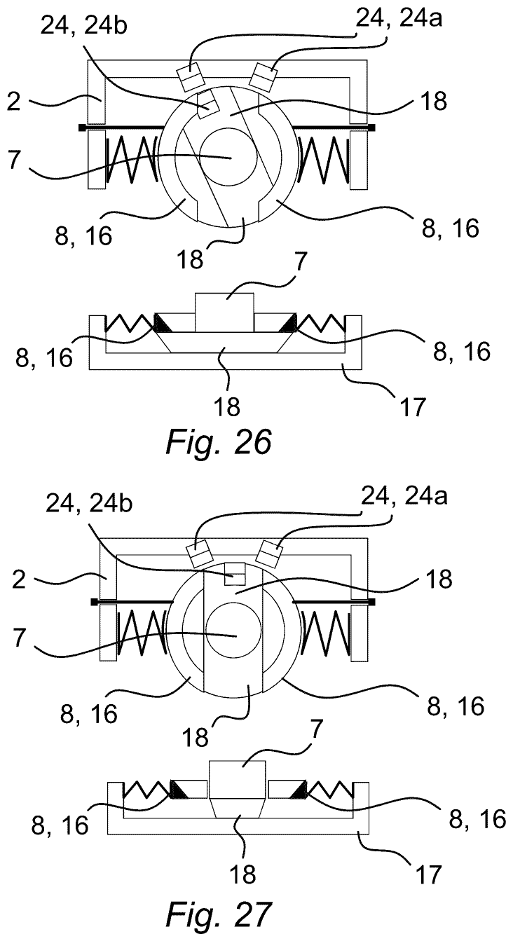

In a fourth variant according to FIG. 26 and FIG. 27, the plug 7 is both centered in the unlocked position by the magnet arrangement 24 and a characteristic overshoot force is generated when the plug 7 is rotated by an angular amount from the unlocked position. This solution thus represents a bi-stable system.

The coupling means 2 can thus comprise at least one first repulsion magnet 24a and the counter-coupling means 3 can comprise a second repulsion magnet 24b, wherein the at least one first repulsion magnet 24a and the second repulsion magnet 24b are arranged relative to one another such that in an unlocking position of the coupling means 2 relative to the counter-coupling means 3, the at least one first repulsion magnet 24a in cooperation with the second repulsion magnet 24b causes a mutually repulsive magnetic force which presses the locking element 8 adjustably mounted on the coupling means 2 into its unlocking position (FIG. 27). In the case of the illustrated embodiment, the coupling means 2 has two repulsion magnets 24a.

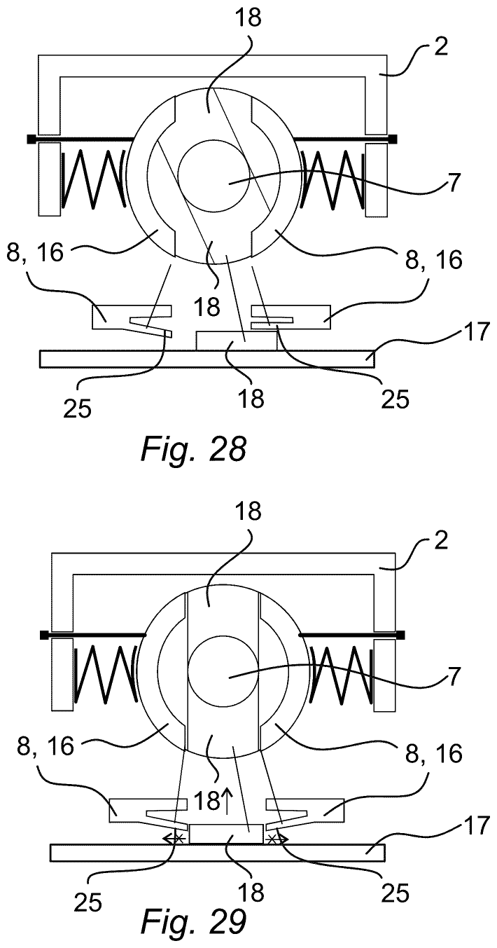

In a fifth variant according to FIG. 28 and FIG. 29, the plug 7 with the locking body 18 is held in the unlocked position by additional locking elements 25 on the counter-holder segments as soon as it has passed over the locking elements, i.e., the counter-holder 16. This fifth variant only allows rotation into the unlocked position, but does not allow backwards or further rotation. In this case, the plug 7 must first be completely removed before the connection is re-established by reinserting it.

The user feels a definite effort when overcoming the locking elements, i.e., the counter-holder 16. In a variation, the locking elements, i.e., the counter-holder 16, can also be part of the frame 17.

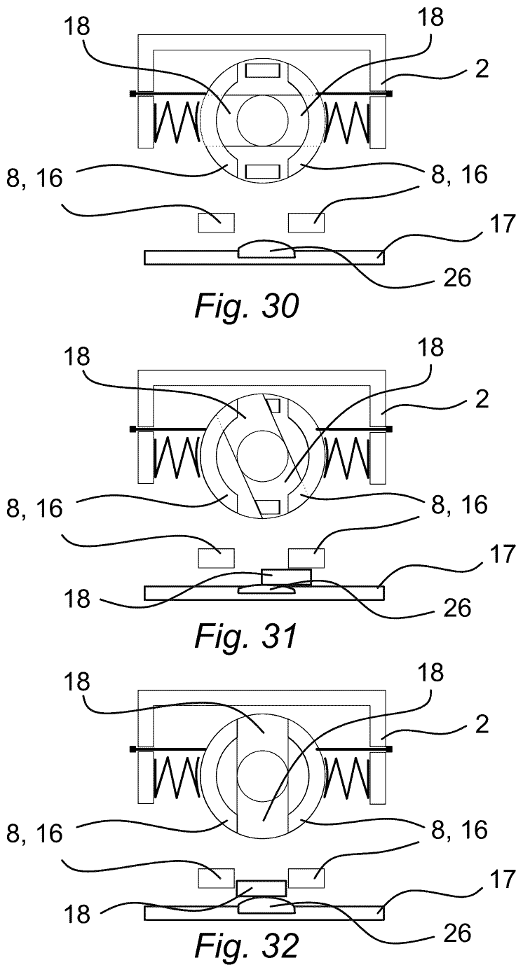

In a sixth variant according to FIG. 30 to FIG. 32, the plug 7 with the locking body 18 is held in the unlocked position by the flanks of the counter-holders 16 as soon as this position is reached. This is achieved by the plug 7 passing with its locking body 18 over an elastic spring element 26 in the frame 17, which slightly lifts it and moves it outwards.

This sixth variant also only allows rotation into the unlocked position, but does not allow backwards or further rotation. Here, too, the plug must first be completely removed before the connection can be re-established by reinserting it. In contrast to the second and fifth variants, a connection can also be re-established by pressing the plug 7 down to the level of the frame 17 against the force of the elastic spring element 26 and then rotating it back into the locking position.

The user feels a definite effort when overcoming the spring element 26. In a modification, the spring element 26 can also be part of the plug 7, in particular of the locking body 18.

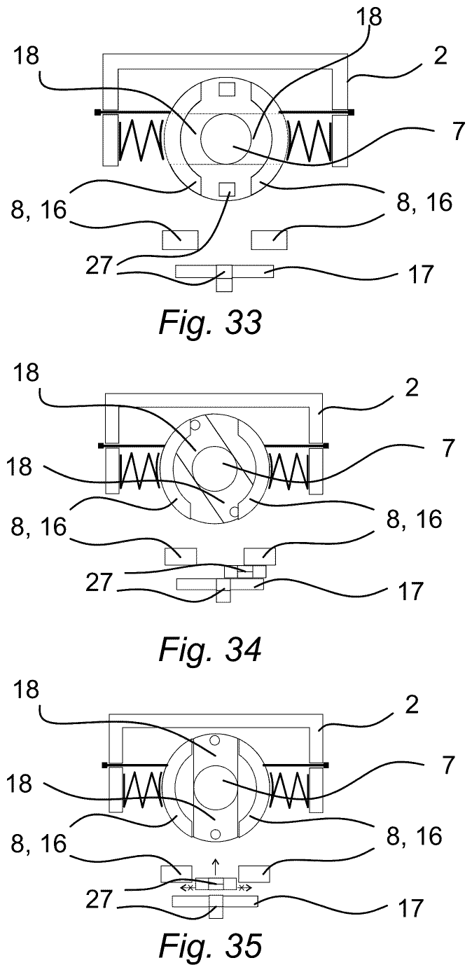

A seventh variant according to FIG. 33 to FIG. 35 is based in principle on the sixth variant according to FIG. 30 to FIG. 32, with the difference that the mechanical spring elements 26 are replaced by magnet pairs 27, which are arranged in particular in such a way that they function by a repulsive effect.

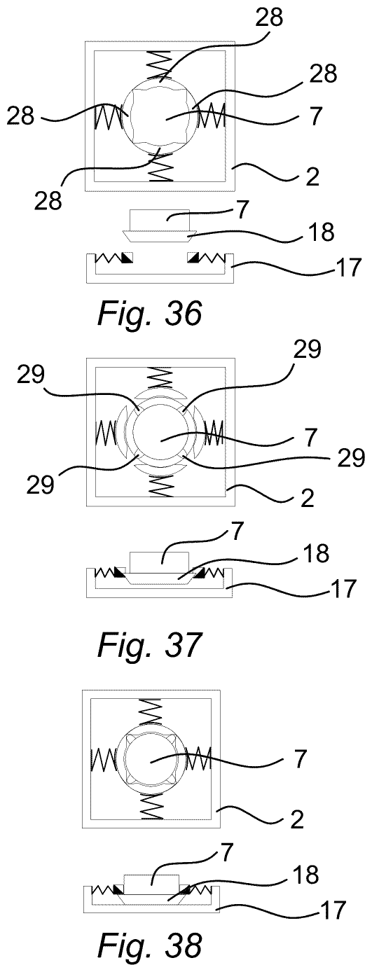

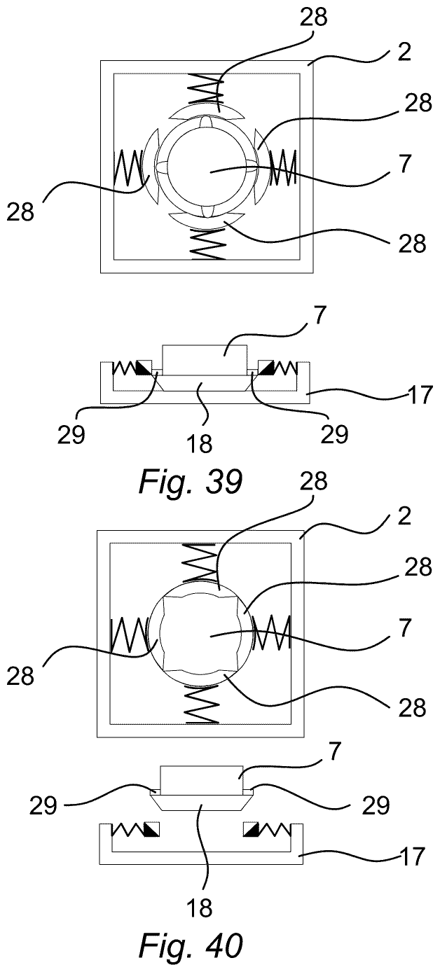

In a further type of embodiments according to FIG. 36 to FIG. 40, the unlocking is not carried out by “free rotation” into a position without overlapping of the locking body 18 and the counter-holder 16; rather, the counter-holder 16, in particular the counter-holder segments, are opened radially outwards by relative rotation of the plug 7 relative to the frame 17 until the plug 7 can be removed opposite the plugging direction S.

This type of embodiment has, for example, four segments 28 as counter-holders 16, each of which has shaped elements, in particular shaped bevels, on at least one side, in particular on both sides. The plug 7, for example, has a continuous locking body 18, which is held in an interlocking manner by the counter-holders 16, i.e., by four segments 28. In addition, the plug 7 has release elements 29 at the level of the counter-holders 16, which elements are located in the free pockets 30 between the segments 28 in the locked state. Rotation causes contact and a guided pressing of the segments 28. The size of the pockets 30 in relation to the size of the trigger elements 29 defines the unlocking time. If the ratio is small, triggering occurs even with a small relative rotation. If the ratio is large, it is the other way around, and the plug 7 remains coupled within a larger angular range.

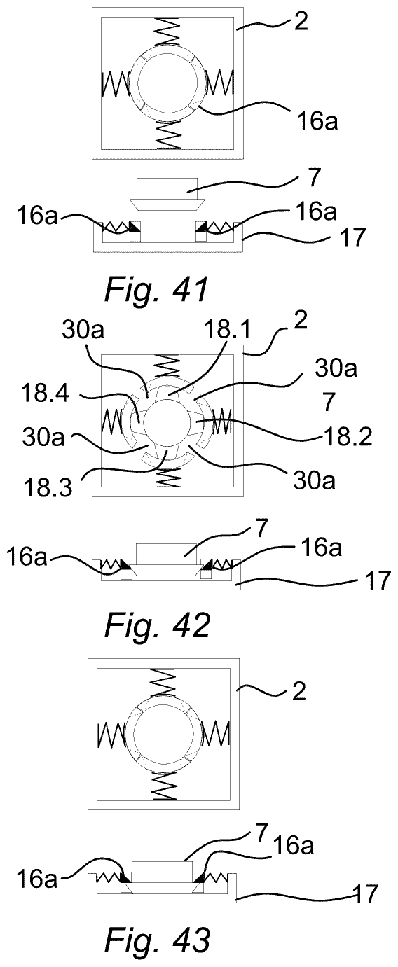

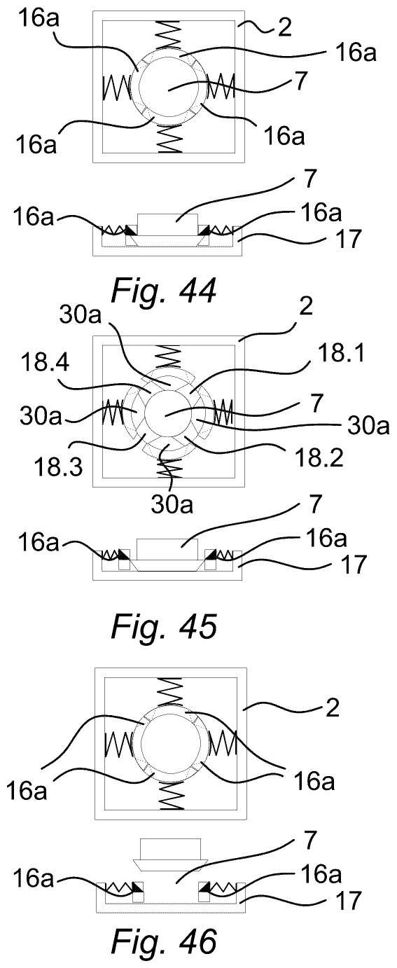

A further type of embodiments according to FIG. 41 to 46 is comparable to the embodiment according to FIG. 36 to FIG. 40, but with the difference that the function of the trigger elements 29 is taken over here by segmented locking bodies 18.1, 18.2, 18.3, and 18.4 and their flanks, which, when rotated, meet shaped elements of joint holder segments 16a. In the locked state, the segmented locking bodies 18.1, 18.2, 18.3, and 18.4 extend into cavities under the joint holder segments 16a. A necessary free space 30a is formed between the segmented locking bodies 18.1, 18.2, 18.3, and 18.4.

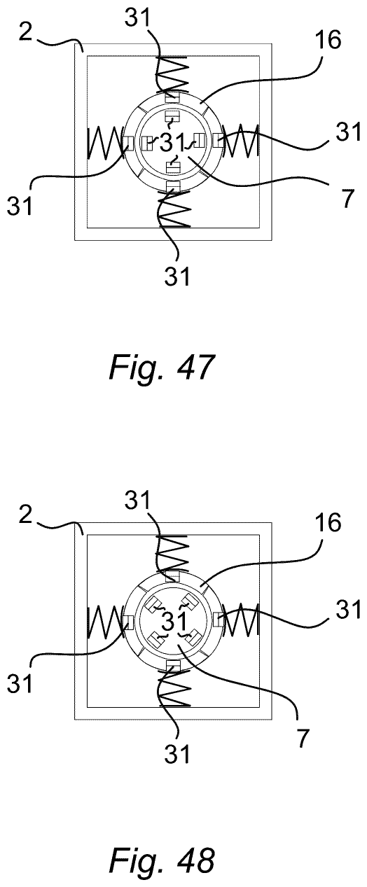

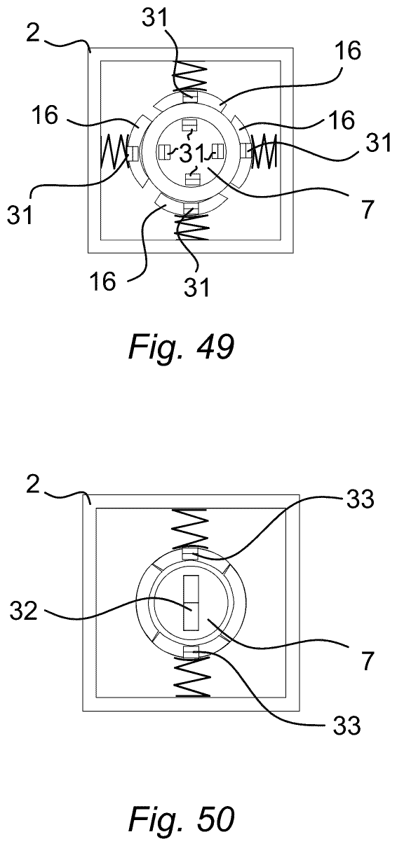

A further variant according to FIG. 47 to 49 with magnets 31 relates to a possible embodiment which does not require free spaces 30a and trigger shape elements, by using magnets 31 which are placed on the plug 7 and the counter-holder 16, i.e., the socket 2. Here the alignment is selected such that the pairs of magnets 31 attract each other in the locked state and provide additional stability, in particular against rotation of the plug 7. If a first force threshold is exceeded, the plug 7 including the inner magnets 31 can be rotated. If the magnets 31 strike the outer magnets 31, which are directed in the opposite direction in this position, they have a repulsive effect and push the counter-holder segments radially back against weaker spring forces.

Analogous to the variant just described, in a modification according to FIG. 50 it can also be provided that only one bar magnet 32 is arranged in the middle of the plug 7 and two segments are formed as counter-holders 16, each with one magnet 33, with one “north” and one “south” pointing inwards.

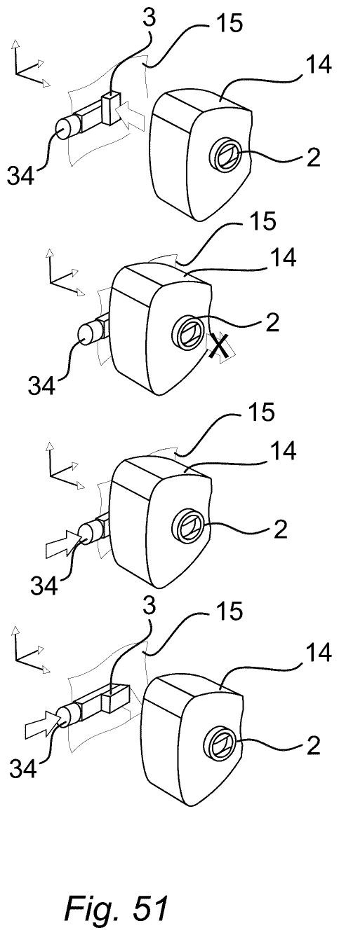

FIG. 51 illustrates how the counter-coupling means 3 can be provided with a manual actuating device 34, via which, alternatively or in addition to an unlocking means 10, which is activated by rotating the coupling means 2 and the counter-coupling means 3, so that the at least one locking element 8 of the coupling means 2 and the at least one counter-locking element 9 of the counter-coupling means 3 can be disengaged.

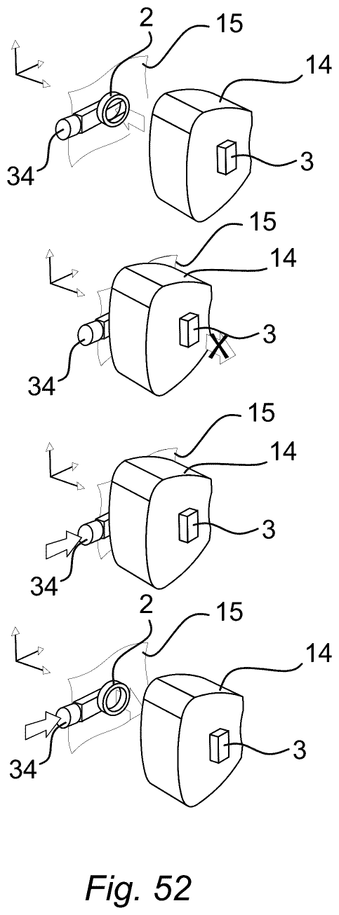

FIG. 52 illustrates how the coupling means 2 can be provided with a manual actuating device 34, via which, alternatively or in addition to an unlocking means 10, which is activated by rotating the coupling means 2 and the counter-coupling means 3, so that the at least one locking element 8 of the coupling means 2 and the at least one counter-locking element 9 of the counter-coupling means 3 can be disengaged.

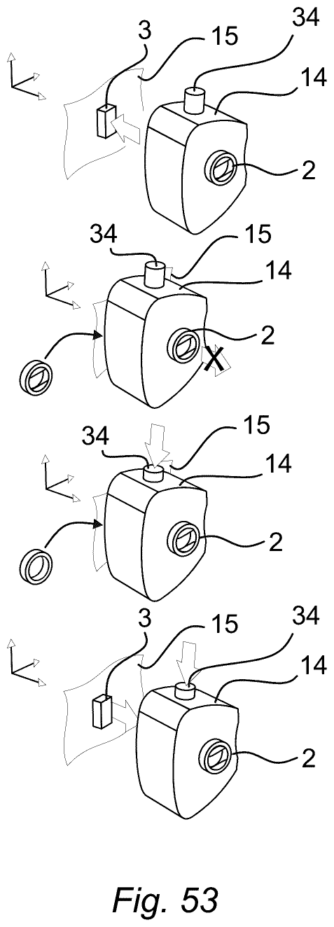

FIG. 53 illustrates how the input device 14 can be provided with a manual actuating device 34, via which, alternatively or in addition to an unlocking means 10, which is activated by rotating the coupling means 2 and the counter-coupling means 3, so that the at least one locking element 8 of the coupling means 2 and the at least one counter-locking element 9 of the counter-coupling means 3 can be disengaged. FIG. 54 illustrates a schematic representation of a system comprising a robot device 15, a robotic input device 14, further terminal devices and a corresponding connecting device 1.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A connecting device (1) for the mechanically interlocking connection of a first object to a second object, comprising:
a coupling means (2) with a first fastening portion (4.1) for fastening the coupling means (2) to the first object, with a socket (5) with an opening through which a socket cavity (6) of the socket (5) is accessible in an axial plugging direction(S), and at least one locking element (8) which is adjustably mounted between a locking position and an unlocking position and which, in its locking position, projects into the socket cavity (6) of the socket (5) and, in its unlocking position, releases the socket cavity (6) of the socket (5),
a counter-coupling means (3) with a second fastening portion (4.2) for fastening the counter-coupling means (3) to the second object, with a plug (7) corresponding to the socket (5) of the coupling means (2) with a shaft that can be inserted into the opening of the socket cavity (6) of the socket (5) in the axial plugging direction(S), and at least one counter-locking element (9) that cooperates in an interlocking manner in the locking position of the locking element (8) of the socket (5),
wherein the socket cavity (6) of the socket (5) and the shaft of the plug (7) corresponding to the socket cavity (6) have cross-sectional contours matched to one another which allow a relative rotation of the coupling means (2) and counter-coupling means (3) about an axis of rotation parallel to the plugging direction(S) in a connected state of the coupling means (2) and counter-coupling means (3),
further comprising an unlocking means (10) arranged on the counter-coupling means (3), which is designed, when the coupling means (2) and the counter-coupling means (3) are rotated relative to each other about the axis of rotation parallel to the plugging direction(S), to move the locking element (8) of the coupling means (2) in a predetermined relative rotation angle position range of the coupling means (2) and the counter-coupling means (3) from its locking position into an unlocking position in which the locking element (8) of the coupling means (2) and the counter-locking element (9) of the counter-coupling means (3) are disengaged, so that the coupling means (2) and the counter-coupling means (3) can be separated from each other opposite the plugging direction(S).

2-11. (canceled)

12. The connecting device according to claim 1, characterized in that the unlocking means (10) has at least one extension projecting radially outward from the shaft of the plug (7), which extension is designed to press the locking element (8) into the unlocking position in a first rotation angle position range of the counter-coupling means (3) relative to the coupling means (2) and to leave the locking element (8) in its locking position in a second rotation angle position range of the counter-coupling means (3) relative to the coupling means (2) that is different from the first rotation angle position range, wherein the locking element is spring-loaded into its locking position and in the first rotation angle position range of the counter-coupling means (3) relative to the coupling means (2), the locking element (8) is pressed radially outward into its unlocking position by the extension of the unlocking means (10) against a spring force.

13. The connecting device according to claim 1, characterized in that the unlocking means (10) has at least one recess (10a) in the outer surface of the shaft, which recess extends axially along the shaft of the plug (7) and is designed to align with the locking element (8) projecting radially inwards into the socket cavity (6) of the coupling means (2) in a first rotation angle position range of the counter-coupling means (3) relative to the coupling means (2), wherein in a second rotation angle position range of the counter-coupling means (3) relative to the coupling means (2), which is different from the first rotation angle position range, the unlocking means (10) overlaps with the locking element (8) in the radial direction, so that in this locking position the counter-coupling means (3) is held in an interlocking manner on the coupling means (2) in the axial direction.

14. The connecting device according to claim 1, characterized in that the counter-coupling means (3) is coupled to the coupling means (2) via a freewheel, such that a relative rotation of the counter-coupling means (3) and the coupling means (2) with respect to each other is only possible in one direction of rotation.

15. The connecting device according to claim 1, characterized by an intermediate plane into which the counter-locking element (9) of the counter-coupling means (3) is introduced when the counter-coupling means (3) is moved by the coupling means (2) opposite the plugging direction(S) in order to separate the counter-coupling means (3) from the coupling means (2) in the unlocking position, wherein the intermediate plane has interlocking retaining means which initially prevent further separation of the counter-coupling means (3) from the coupling means (2) across the intermediate plane and which only permit this further separation after an additional rotation of the counter-coupling means (3) relative to the coupling means (2) by a further angle of rotation.

16. The connecting device according to claim 1, characterized in that in a relative angular position of coupling means (2) to counter-coupling means (3) corresponding to the unlocking position, the plug (7) of the counter-coupling means (3) is held stabilized in its unlockable rotational position by means of a locking device (35) relative to the socket (5) of the coupling means (2) in a force-locking and/or interlocking manner.

17. The connecting device according to claim 16, characterized in that the locking device (35) comprises a locking pin (22a) which is pre-tensioned on the coupling means (2) so as to project in the radial direction into the socket cavity (6) and which, in the unlocking position, mechanically locks into a recess (23a) in the shaft of the plug (7) corresponding to the locking pin (22a) of the counter-coupling means (3).

18. The connecting device according to claim 16, characterized in that the locking device comprises a first magnet (24.1) attached to the coupling means (2), which in the unlocking position magnetically interacts with a second magnet (24.2) arranged on the counter-coupling means (3) in order to hold the counter-coupling means (3) in its current rotational angle position relative to the coupling means (2) in the unlocking position.

19. The connecting device according to claim 1, characterized in that the coupling means (2) comprises at least one first repulsion magnet (24a) and the counter-coupling means (3) comprises a second repulsion magnet (24b), wherein the first repulsion magnet (24a) and the second repulsion magnet (24b) are arranged relative to one another in such a way that in an unlocking position of the coupling means (2) relative to the counter-coupling means (3), the at least one first repulsion magnet (24a) in cooperation with the second repulsion magnet (24b) causes a mutually repulsive magnetic force which presses the locking element (8) adjustably mounted on the coupling means (2) into its unlocking position.

20. A system comprising a robot device (15), a robotic input device (14) and a connecting device (1) according to claim 1, characterized in that the coupling means (2) is connected to the robot device (15) as a first object by means of its first fastening portion (4.1) and the counter-coupling means (3) is connected to the robotic input device (14) as a second object by means of its second fastening portion (4.2), wherein the connecting device (1) is designed and configured according to any of claims 1 to 9 for manually selectively connecting and separating the robotic input device (14) and the robot device (15).

21. A system comprising a robot device (15), a robotic input device (14), and a connecting device (1) according to claim 1, characterized in that the coupling means (2) is connected to the robotic input device (14) as a first object by means of its first fastening portion (4.1) and the counter-coupling means (3) is connected to the robot device (15) as a second object by means of its second fastening portion (4.2), wherein the connecting device (1) is designed and configured for manually selectively connecting and separating the robotic input device (14) and the robot device (15).
